(19) United States
(12) Patent Application Publication
(10) Pub. No.: US 2004/0222611 A1
(43) Pub. Date: Nov. 11, 2004

(54) Programmable multifunctional air support reclining and tilting wheelchair

(76) Inventors: Richard Fenwick, Port Jefferson, NY (US); Greg Gunther, Shokan, NY (US)

Correspondence Address: SCULLY SCOTT MURPHY & PRESSER, PC, 400 GARDEN CITY PLAZA, GARDEN CITY, NY, 11530

(21) Appl. No.: 10/838,992

(22) Filed: May 5, 2004

Related U.S. Application Data
(60) Provisional application No. 60/468,203, filed on May 6, 2003.

(51) Int. Cl. B62M 1/14

(52) U.S. Cl. 280/250.1

(57) ABSTRACT

A reclining and tilting wheelchair includes a seat and back support cushion containing a plurality of matrices of air cells capable of being individually programmed to inflation and deflation. The wheelchair is multifunctional and is useful in facilitating daily activities, physical therapy, and reducing decubiti and the number of patient transfers.

### CROSS-REFERENCE TO RELATED APPLICATION

The present application is based on and claims the benefit of co-pending U.S. Provisional Pat. application No. 60/468,203 filed May 6, 2003 the whole contents and disclosure of which is wholly incorporated herein by reference.

### FIELD OF THE INVENTION

The subject invention generally relates to wheelchairs. More specifically, the subject invention relates to a multifunctional reclining and tilting wheelchair having a seat support to relieve pressure points and assure spinal alignment.

### BACKGROUND OF THE INVENTION

There are approximately one million wheelchair patients in the United States. Patients who are wheelchair-bound remain seated in their chairs for an average of 14 hours a day. Wheelchair occupants are often unable to move easily, to for example, shift their weight. Constant pressure on one point can lead to the loss of circulation and the formation of decubiti ulcers, sores and the like, particularly problematic in patients with impaired sensation.

In addition to decubiti ulcer formation, other secondary problems caused by improper wheelchair seating and/or design are edema, restricted respiration and gastrointestinal tract function, posture deformation, pain, and injury secondary to incidental contact with elements of the wheelchair.

Decubiti ulcers or pressure sores primarily develop from the pressure and weight of one's own body pressing the skin and other tissues between the person's bone(s) and a firm surface, such as the seat of a wheelchair or from friction. The most common site for the development of a decubitus ulcer is upon the coccyx or buttock when someone sits for extended periods of time without changing position. Also, areas on the backs of the arms and legs are especially prone to the development of decubitus ulcers if the person is paralyzed and the limbs are resting upon the hard surfaces of a wheelchair's arm or leg rest.

Pressure is calculated in units of force per unit of area. Pressure is exerted on the skin, soft tissue, muscle, and bone by the weight of an individual against a surface beneath. These pressures are often in excess of capillary filling pressure, approximately 32 mm Hg. The greater the area over which a given force is applied, the lower the pressure. A number of factors effect pressure distribution such as asymmetrical sitting posture, spine collapse or both, body build (Dinsdale, S., “Decubitus ulcers: role of pressure and friction in causation”, Arch Phys Med Rehab, 55: 147-52, (1974).) For example, sitting pressure measurements vary significantly in paraplegic and elderly people than for neuromuscularly healthy people (Bennett, L., Kavner, D, Lee, B. et al, “Skin stress and blood flow in sitting paraplegic patients”, Arch Phys Med Rehab 50: 587-94, (1969).)

In patients with normal sensitivity, mobility, and mental faculty, pressure sores are unlikely to develop as feedback, both conscious and unconscious, from the areas of compression leads the individual to change body position. Individuals unable to avoid long periods of uninterrupted pressure over bony prominences are at increased risk for the development of necrosis and ulceration. This group of patients typically includes the elderly and those who are neurologically impaired or demented. These individuals cannot protect themselves from the pressure exerted on their bodies unless they consciously change position or have assistance in doing so.

The primary goal of decubitus ulcer treatment is prevention. One method to prevent decubiti is to adjust the area in which the patient or patient applies most of his or her weight, commonly referred to as a pressure point. Preventative measures for wheelchair-bound patients include a shift of weight in the wheelchair every 10-15 minutes. Alternating pressure or rotation of pressure points has been shown to be an effective treatment for the prevention of pressure sores, especially in the area of the ischial tuberosities. However, in many cases the patient forgets to move, or may be unable to move themselves. Consequently, requiring the patient to self-reposition in the wheelchair every 10-15 minutes is unrealistic.

Wheelchairs typically have sling seats which hang from parallel rails disposed horizontally as part of the frame of the wheelchair. Since the seat must support the weight of a person, it is typically made of a foam cushion element, with hard materials or a rigid intermediate member, typically a hard wooden board, surrounded by a cover. The rigid intermediate member is provided to support the cushion so that it will lie on a flat horizontal surface. Sitting in a sling seat for extended periods of time increases seating pressures and associated forces upon the hips and thighs which effect the alignment of the pelvis and spine. Further, conventional sling seats restrict the movement of the patient. This results in an uncomfortable seat which increases the risk of decubiti or pressure sores.

Attempts to reduce the frequency of decubitus ulcers include the use of various seating cushions for minimizing the seating or capillary pressure to less than 32 mm Hg and to provide maximum comfort to the wheelchair occupant.

Contoured cushions such as angled back and seat supports and bi- and tri-angular cuts in the backrest are of limited value for achieving contact, support, and weight distribution. For many patients, custom molded back and seating systems (e.g. pour in space type mold) are often necessary to alleviate postural deformities and provide maximum support and weight distribution. However, there are problems using custom molding. For example, the patient is essentially locked into position; once molded, most systems, are impossible to make changes to even if they do not exactly fit. This inexact fit can lead to decubiti formation over those areas supported by a built-up area in the mold that was intended to fill a void (i.e., a lordosis). The only adjustments available are seat to back angle and seating system position within the mobility base. Foam densities, trunk/hip lateral positioning, height, weight, length, width, and all the contouring are non-adjustable even if the patient grows or sustains a breakdown or complains of discomfort over a specific area of the mold.

Moldable plastic and metal matrix/lattice-type molded back and seating systems require tightening screws that lock at each crossing point or joint. There may be more than 200 joints that need to be positioned and tightened. Therefore, this system is extremely labor intensive and requires a high degree of technical and mechanical expertise. Not only must the individual be molded by the therapist but a frame that acts as a superstructure must be built for the mold. Additionally, an attachment structure to the mobility base must be built.

Additionally, the use of custom molding eliminates the use of a recline option that allows the patient to change his trunk-to-back angle and reduce weight-bearing over the buttocks. If a recline is used, it will change the position of the patient in relation to the high and low points of the molded system, potentially forcing a built up area designed to fill a concavity to make sustained contact with a body convexity.

Other problems are inherent in custom molding. The molding process requires that the therapist be extremely accurate and thorough when molding to ensure that the contour accurately mirrors the patient's invaginations and deformities. Turnaround time is also a problem. It may take 3-4 months for a typical mold to be sent to the manufacturer and returned to the durable medical equipment vendor. It is possible that within this extended waiting period, the patient's body may be changed enough that the mold is no longer viable.

Cushions with foam, jell-foam (gel), and fluid-filled devices have been used to prevent decubiti and shear or friction. These materials are heavy. Cushions with multi-zone or sponge rubber egg-crate designs, sheepskin covers have also been used.

Other methods to increase comfort include sculpting the cushion or using different types of foams, such as those with lower density. For example, U.S. Pat. No. 4,522,447 to Snyder describes a horseshoe shaped seat comprised of foam of different densities. This seat is difficult to make because separate molding parameters are required for each foam density, and it does not solve all the discomfort problems of wheelchair occupants. Other cushions, utilize a cut out opening at locations corresponding to maximum pressure points or are contoured by orthotist's (Bokhaut, F. “Decubitus ulcers and wheelchair cushions. A review of the literature”, Can J Occup Ther., 47:111-115, (1980); Shaw, G, “Wheelchair seat comfort for the institutionalized elderly”, Assist Technol, 3: 11-23, (1991).) The Jay cushion is an example of a contoured cushion designed to reduce pressure.

Problems with these cushions include that the patient will not position exactly over the cutout consistently. It is also nearly impossible for caregivers to position the patient in exactly the same spot each time. Therefore, a larger cutout must be made to accommodate this variation in positioning, decreasing the overall area in which to distribute the individual's weight even further and, in turn, potentially jeopardizing adjacent areas by making them bear more weight. Further, these cushions require that the caregiver be trained how to properly position the patient.

For institutionalized patients or patients who remain in bed for long periods or who are bedridden whose disease or disability makes turning in bed either difficult or impossible, air mattresses, rotating beds, automatic turning mattresses, and specialized flotation beds which are intended to equalize and distribute pressure over the body have been used. Air-fluidized beds suspend the patient as air is pumped into an air-permeable mattress containing millions of microspheric uniformly sized silicone-coated beads. Low-airloss support the patient on multiple inflatable air-permeable pillows. No one device has been shown to be clearly superior over the others, but they have been shown to reduce tissue pressure over conventional hospital mattresses and wheelchair cushions.

Previous wheelchairs use gel packs, foam padding, pillows and other support devices to make the wheelchair occupant comfortable. Pneumatic cushions with air-filled cells or gel have been used. However, these cushions are produced in relatively costly dip molding processes. Pneumatic cushions have inherent problems from air leaks, inaccurate adjustment, improper positioning, deterioration of the cushion, as well as over or under inflation. Further, when placed on a catenary seat, control of the upper surface of the cushion is lost when the cushion conforms to the seat.

Certain other prior art cushions utilize inflatable compartments filled with air or a gel in which pressure is alternatively raised or lowered in different compartments sequentially so that the area of maximum pressure is not always in the same location. However, such prior art inflatable cushions cannot ensure that the seating pressure is adequately reduced when a particular compartment is deflated, since the deflated compartment may still remain in contact with the seated individual.

U.S. Pat. Nos. 5,163,196, 6,564,410 and 5,845,352 to Roho, Inc. are directed to air flotation seat cushions for wheelchairs where air cells are interconnected; that is air slowly transfers from chamber to chamber or the air cells are grouped into quadrants where each quadrant may be inflated separately and the air is locked into place in each quadrant. The cells are not individual nor are they adjustable. All of the cushions are seat cushions.

ErgoDynamic™ technology eliminates pressure over the ischial tuberosities at three minute intervals, aerating the pelvis and increasing blood and lymph flow up to 500%. Shear forces are controlled by the slightly recessed seat design and a pre-ischial crossbar that prevents the client from slipping forward in the chair, supporting the patient in an upright position. The wheelchair is non-reclinable.

U.S. Pat. No. 5,839,140 is directed to an inflatable wheelchair cushion with a plurality of fluid-filled cells. However, inflation and deflation of the individual cells is not possible and the wheelchair is non-reclining. Inflation of the cells requires a valve like that used to inflate a basketball or pneumatic tires.

U.S. Pat. No. 6,557,937 discloses a wheelchair seating apparatus consisting of a plurality of rigid slats which are movable between a first and a second position to provide intervals of seating pressure reduction below a predetermined seating pressure for a predetermined period via a controller. The wheelchair is non-reclining.

There is no teaching in these references for a back support for a wheelchair with a plurality of air-filled cells which can be individually inflated and deflated.

Conventional wheelchairs typically comprise non-reclining seats. Reclining wheelchairs were developed to prevent development of sores or flexion contractures of the hips and knees and for patients with kyphosis. Kyphosis, an abnormal curvature of the spine, which commonly afflicts the elderly, is aggravated by sitting upright for long periods of time. Persons suffering this condition may be forced to remain in bed for a greater portion of the day, adversely affecting their quality of life. Reclining wheelchairs permit the patient to undergo physical therapy and are beneficial for patients with hip extension contractures. Reclining wheelchairs are usually dependent, that is they are useful for those unable to shift their own weight without assistance. Additionally, reclining wheelchairs have a long base for stability, removable armrests, patient operated wheel locks, and a head support.

Reclining wheelchairs are indicated when the patient spends at least two hours per day in the wheelchair and has one or more of the following conditions: quadriplegia, fixed hip angle, trunk or lower extremity casts or braces that require the reclining back feature for positioning, excess extensor tone of the trunk muscles, or the need to rest in a recumbent position two or more times per day and where transfer between wheelchair and bed is very difficult.

Reclining wheelchairs may also be useful to facilitate everyday activities for wheelchair bound individuals. For example, common services such as hair care, dental work, physical therapy or other heath care services require a person to be placed in a reclining position. Physically lifting a wheelchair bound person to a reclining position is generally awkward and potentially dangerous for both the person and the service provider.

Various reclining wheelchairs are available. Unfortunately, reclining wheelchairs are heavy, bulky and very costly when compared to non-reclining wheelchairs. Additionally, reclining wheelchairs do not utilize adjustable air pressure seating. Further, for reclining wheelchairs, it is the back of the seat or backrest which may be moved backwardly.

U.S. Pat. No. 6,409,265 is directed to a reclining wheelchair wherein the seat and back frame can be rotated individually. The wheelchair does not allow the patient to lie flat. The wheelchair consists of a linkage mechanism to tilt the seat and back frame.

U.S. Pat. No. 6,370,716 is directed to an inflatable cushioning device with a tilting apparatus for use with mattresses, seats, sofas where support is obtained from a fluid such as atmospheric air. The cushioning device includes a tilting apparatus to provide easy rotation of a patient lying on a bed and to assist in moving patients when in a chair or a bed. The air cells act as a hydraulic lift, tilting the patient around by deflating one side and inflating another. However, this device is not used directly for patient comfort or to reduce pressure points.

U.S. Pat. No. 6,015,256 discloses a device for tilting a wheelchair and its occupant to a reclining position such as required for receiving common services such as having their hair done or dental work performed. The device includes a wheel immobilizer and a tilting assembly for receiving the handle and back support of the wheelchair. Additionally required is a drive mechanism for tilting the wheelchair, such as those known in the art to adjust the angle of a hospital bed. Examples are an electric motor, a pneumatic drive or a hydraulic drive. The chair utilizes large rear wheels which are secured so that they provide a fulcrum for the chair's wheel axis to pivot upon when a tilt bar is extended or retracted.

No single prior art wheelchair simultaneously addresses all of the above-mentioned problems and incorporates the ability to recline to a lay-flat position together with the ability to tilt the wheelchair, and has adjustable air pressure seating and back support.

The present invention is directed to reduce or overcome the disadvantage of the prior wheelchairs by being capable of providing alternating pressure relief, support, positioning, and comfort for the patient which can be sculptured to suit their individual needs.

### SUMMARY OF THE INVENTION

The present invention recognizes and addresses various of the foregoing problems, and others, concerning support of long term confined patients, or others for whom improved seating comfort, pressure relief, support and positioning are desired.

According to the invention there is provided a wheelchair with a pair of rear wheels; a pair of front wheels; a chassis connecting the front and rear wheels; a seat support cooperating with the chassis and including a seat back and a seat bottom with a plurality of matrices of air support cells which can be individually inflated and deflated, and where the seat back is capable of being reclined with respect to the seat bottom and the seat support is capable of tilting with respect to the frame. Attached to the seat support is a means to individually inflate and deflate one or more air cells in the plurality of matrices; the means to inflate and deflate the air cells of the seat support is connected to a controller, whereby the patient can individually inflate and deflate one of more air cells in each of the plurality of matrices, thereby relieving pressure and friction forces in the back and lower body regions.

It is an object of the present invention to provide a wheelchair comprising a seat and back support made up of matrices of individual air cells that can be individually programmed via a programmable controller to inflate and deflate. By alternating air pressure, pressure points are countered, thereby reducing the risk of skin break down and pressure sores. Additionally, the air cells provide the patient with proper positioning and corrective spinal alignment.

It is a further object of this invention to provide a wheelchair with both seat frame tilting and back reclining features. The tilting nature of the wheelchair permits the entire seat frame to tilt with respect to the chassis. The chassis of the invention lies underneath the seat frame and is ergometrically designed to prevent tipping over. The reclining nature of the wheelchair permits the seat back to lock in any position from about 90° to about 180°. When the seat is planar (i.e., 180°), then the seat back may fully recline or tilt downward to about −45° with respect to the horizontal while the seat base tilts up to about 135° with respect to the horizontal.

The three features together, i.e., the inflatable back and seat cushion, together with the tilting and reclining nature of the wheelchair have additive beneficial effects for wheelchair bound patients.

The cells of the seat and back support are individually inflated and deflated for ensuring positive blood flow to soft tissue areas under the compression forces due to sitting. The cells are designed to inflate to keep pressure in the capillaries at 32 mmHg or less. The alternating pressure in the back and seat cushion prevents decubitis ulcers and promotes healing for those who have them. The air cells work as mini shock absorbers; they adjust to the patient's shape as they sit in the wheelchair.

It is therefore, an object of the present invention to provide a multifunctional wheelchair which provides comfort and therapeutic support and alleviates the problems inherent with a patient or patient sitting for prolonged periods of time adapted for simultaneously providing a reclining back and tilting feature to eliminate friction forces of the patient's back.

It is another object of the present invention that the tilting and reclining features reduce the number of transfers into and out of the wheelchair.

It is an additional object to provide a multifunctional wheelchair that facilitates everyday activities such as hair care, dental care, physical therapy, health care or aid-related services such as diaper or dressing changes.

Yet another object is to provide a reclining and tilting wheelchair that functions as a side lyer for patients with neurological or muscular disorders or conditions.

A further object of the present invention is to provide a reclining and tilting wheelchair with a back support and seat comprised of a matrix of air-filled cells that is economically constructed, and does not involve complicated forming or molding steps.

Further, the present invention is directed to a method of treating and preventing decubiti ulcers. The method includes steps of providing a wheelchair that has a back apparatus that reclines and has a seating and back apparatus that consists of a matrix of air cells, and a controller allowing the patient to individually program inflation and deflation of the air cells; where an immobilized person on the wheelchair having a decubitus ulcer on a lower body region inflates and deflates air cells on an individual basis, thereby relieving pressure in the lower body region.

The present invention discloses a method of preventing decubiti ulcers comprising providing a wheelchair with an air support back and seat cushion that reduces pressure on the portion of a patient's body in contact therewith and assures posture and spinal alignment.

In addition, an object of the invention is to provide a wheelchair that allows the patient to customize the amount of pressure to account for leakage or changes in temperature or altitude which result in changes in inflation.

It is another object of the present invention to provide a wheelchair achieved with a methodology that is cost effective, while still achieving advances in practical performance.

While the invention is directed to a manual wheelchair, it is applicable to electric, power, or motorized wheelchairs. A patient who requires an electric, motorized, or power wheelchair usually is totally nonambulatory and has severe weakness of the upper extremities due to a neurological or muscular disease or condition.

Other objects, features and advantages of the invention shall become apparent as the description thereof proceed when considered in connection with the accompanying illustrative drawings.

### BRIEF DESCRIPTION OF THE FIGURES

FIG. 1 is a side view of the wheelchair in a slightly reclined position.

FIG. 2 is a side view of the wheelchair in a slightly reclined and fully tilted position.

FIG. 3 is a side view of the wheelchair in a planar reclined position.

FIG. 4 is a side view of the wheelchair in an upright and tilted position.

FIG. 5 is a cross-sectional view of the adjustable air cells of the seat bottom.

FIG. 6 is a cross-sectional view of the adjustable air cells of the back support.

FIG. 7 is an isometric view of the side elevation of the chassis with angled cross member.

FIG. 8 is a side view of the chassis and an internal view of the seating.

FIG. 9 is a schematic diagram of the air cell system and programmable controller.

FIG. 10 is a rear view of the wheelchair control panel showing the battery, the air pump, a bank of solenoids, gas springs and the actuator and release valve for the gas springs.

### DETAILED DESCRIPTION OF THE INVENTION

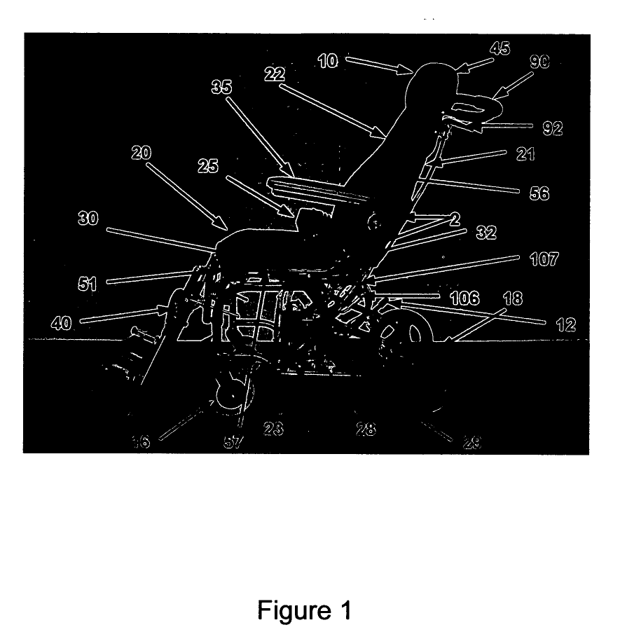

Referring initially to FIG. 1, a wheelchair in a slightly reclined position, designated generally as 10, is shown. Wheelchair 10 includes a frame 2 supported by a chassis structure 14 that is mounted for movement on a plurality of front caster wheels 16, and rear drive wheels 18. The wheelchair frame 2 includes a seat support 21 having seat bottom 57 and seat back 56 portions, the seat bottom supporting a seat bottom cushion 20 and, the seat back portion 56 supports a seat back cushion 22. The seat back portion 56 may be reclined with respect to the seat bottom 57 by a cranking or push button mechanism 32 and the entire seat support 21 may be tilted or angled with respect to the horizontal via a release mechanism 106. The seat bottom cushion 20 and seat back cushion 22 also may include a base of foam 51. The seat bottom and seat back can be made from steel, rubber, plastics, foam or any suitable material for structure. The seat size can be custom made to fit a specific patient.

In the preferred embodiment, each seat bottom cushion 20 and seat back cushion 22 comprises a plurality of inflatable/deflatable air cells. That is, the seat bottom cushion 20 and back support cushion 22 of wheelchair 10 each comprise a plurality of air cell matrices 30 on a foam base 51 that include air cells adaptable for individual inflation/deflation. Mounted at the bottom of the chassis structure 14 and supported thereby is a bottom plate 23 upon which is located a controller 25, an inflation/deflation means 29, e.g., air pump or like device for inflating/deflating air cells in the manner as will be described in greater detail herein, and, a power source 28 for operating these devices.

The wheelchair 10 further includes a handlebar 90 that is attached to the seat back portion 56. The handlebar has multi-purpose handles to permit easy maneuverability when steering the chair. As will be explained in greater detail, the seat as a whole tilts back after releasing pressure stored in gas springs and the chair may be manually tilted using the handlebars. The tilting does not significantly shift the wheelchair's center of gravity.

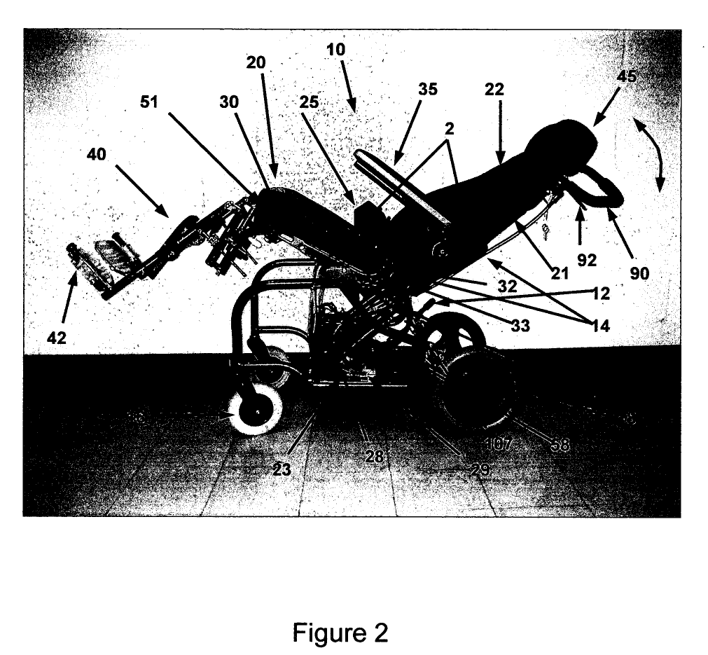

FIGS. 1 and 2 show the handlebar 90 of the present invention together with the two levers 92. As further illustrated, a patient positioned in the wheelchair may have his/her arms supported by armrests 35, legs supported by legrests 40 that can be elevated, and feet supported by extendable footrests 42. A headrest 45 may be further mounted at the top end of the seat back portion 56. Extendable elevating legrests 40 and footrests 42 are mounted to the frame 2 and are removable. The footrests 42 and legrests 40 are preferably padded for comfort. For added length and leg support during a completely reclined position, the footrest will swing up in line with the seating surface to create a full length bed for the patient. The footrest does not fold down. With respect to the headrest 45, a slot 75 is located on the top of the back seating surface for the addition. This feature permits the head support to be custom designed to meet the specific needs of the patient. When the chair is placed in a reclining position, a wide, extra padded head support is added to further provide length and comfort to the bedlike surface. As further depicted in FIGS. 1 and 2, the armrests or arm supports 35 are mountable to the sides of the seat back frame portion 56. A padded cushion is provided atop the armrests 35. Preferably, the armrests 35 are able to swing upwards and away to enable the patient to the transported into and out of the wheelchair. This feature facilitates easy exit from the chair to the toilet or bed. Additionally, the arm supports are capable of being tilted with the seat back so that the angle of the arm support with the seat bottom is not changed.

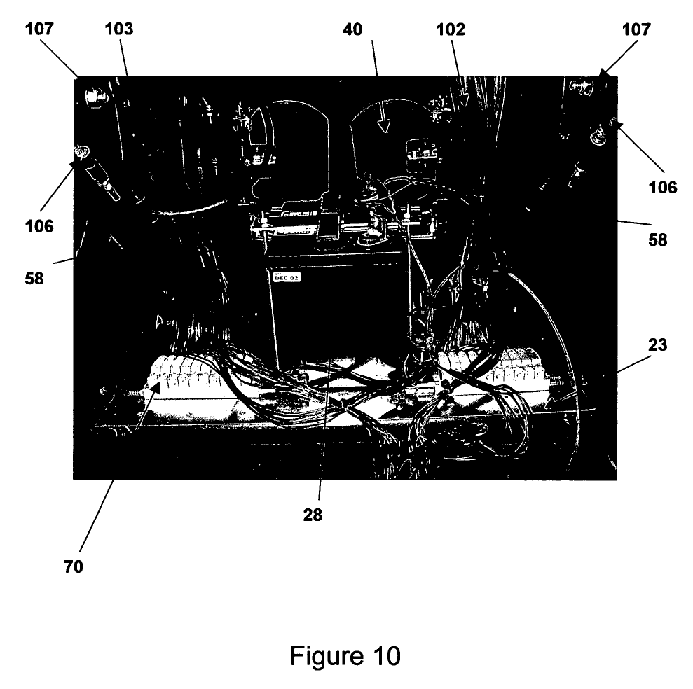

FIG. 2 shows the wheelchair 10 with the frame seat back portion 56 reclined and the seat support 21 tilted with respect to the horizontal. In one embodiment, tilt-assist locking gas springs 58 are used to achieve easy tilting positioning as indicated by the arrow depicted in FIG. 2. The gas springs 58 operate to facilitate the tilting frame via the release mechanism 106, e.g., an actuator, and a release valve 107. Preferably, two gas springs 58 may be used to assist in tilting the wheelchair. An example gas spring that may be implemented includes the BLOC-O-LIFT™ (J.W.F. Technologies). Each spring 58 is mounted to the inner part of each side of the frame 2 such as shown in FIG. 10. The spring preferably connects on an angle to the bottom of the seat base in order to provide optimum space for the air cell power components on the chassis base plate. The gas springs have a constant exertion force and, as further shown in FIGS. 1 and 2, two levers or spring releases 92 (one for each gas spring) are mounted on the handlebars and manipulated to release the gas spring valves to enable tilting. FIG. 10 shows the gas springs 58, an actuator 106 and a release valve 107 for the gas springs.

The wheelchair 10 is adapted to be tilted by compressing the springs 58. The chair may be in position at any point within the tolerance of the gas spring. At full compression the chair tilts at approximately 40° parallel to the chassis. When the wheelchair is brought back to the upright position, the levers 92 are squeezed to open the valves. With minimal assistance in lifting, the wheelchair is brought back to an initial upright position. The spring's constant exertion force assists in lifting the patient situated in the wheelchair. Wheel immobilizers 12 shown in FIG. 1 may be provided to keep the wheelchair stationary during and after tilting using the handle levers. The wheel immobilizer 12 may be any known to those skilled in the art such as clamps, wheel chocks, hooks, and detents.

As mentioned, the seat back frame portion 56 of wheelchair 10 can be reclined (angled) with respect to the seat bottom portion 57. This seat reclining feature is facilitated by a cranking mechanism 32 of conventional design to allow variable seating angles from 90° to 180° at a pivot point 33. It is understood that the seat back cranking mechanism 32 may be power driven via a battery (not shown). In one embodiment, a gearing assembly such as utilized in automobile seats may be used. It is further understood that the seat back recline crank mechanism 32 may drop the seat back frame portion to provide a flat or horizontal (planar) wheelchair support position. More particularly, the seat support 21 focuses on leg, trunk and head alignment, lumbar and neck support and an adjustable restraint or seat-belt type system. The seat back 56 is capable of being adjusted to vary the angle between the seat bottom 57 and the seat back 56. The chassis 14 of the wheelchair 10 is adjustable to allow the seat back 56 to recline from 90° to about 180° at a pivot point 33 (shown in FIG. 2) while maintaining stable support of the patient. The seat back and bottom in the planar reclined position is capable of being tilted. The bottom seat 57 tilts up as the seat back 56 reclines or tilts downward.

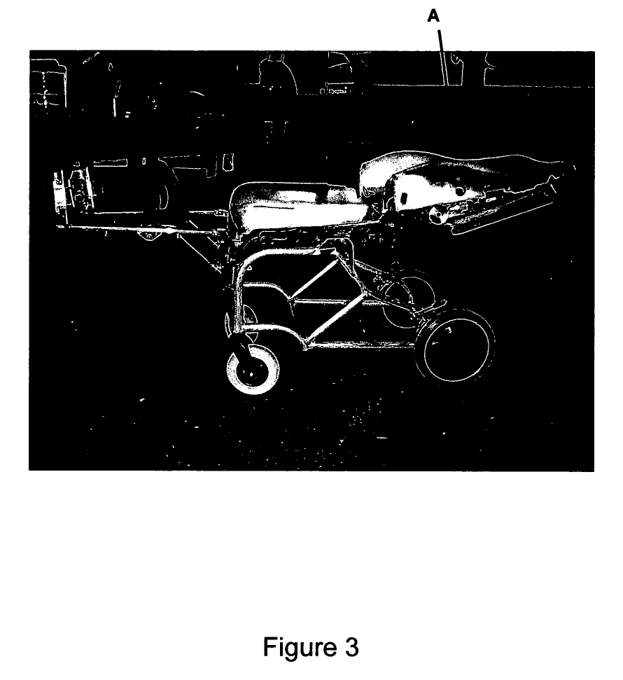

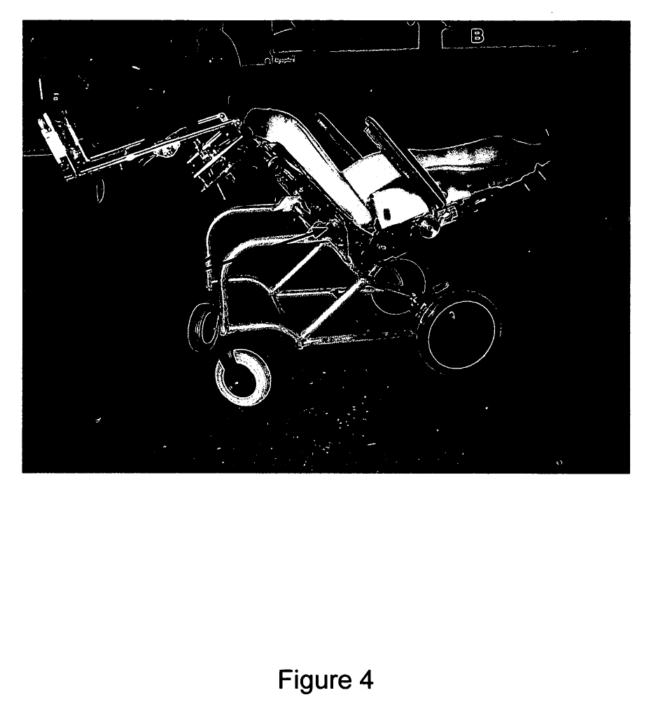

FIG. 3 shows the wheelchair 10 in such a planar reclined position (A) and FIG. 4 shows the wheelchair 10 in an upright position with the whole seat support 21 angled with respect to the horizontal (B). Referring to FIG. 3, when the seat back 56 is reclined to 180°, the leg support assembly, i.e. the legrests 40 and footrests 42, is fully extended to a planar position, such that the entire wheelchair assumes a generally flat, horizontal position (i.e., 180°). The ability of the wheelchair to recline to an even plane (180°) such as shown in FIG. 3 allows the patient to lie on their side. This side lying is advantageous for use during a session with a therapist or to facilitate changing absorbent undergarments or diapers, or dressings. If the air cells on one side of the seat bottom 57 and seat back 56 are inflated, the wheelchair functions as a side layer. The side lying position provides postural control so that a variety of living skills can be provided with ease. For example, for children with cerebral palsy or other neurological disorders, side lying is used to promote eye-hand coordination and bilateral play skills.

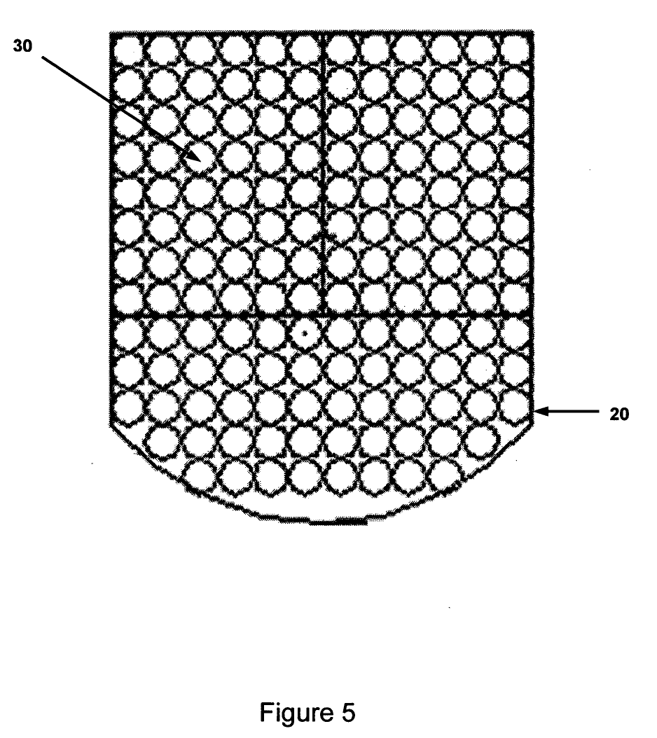

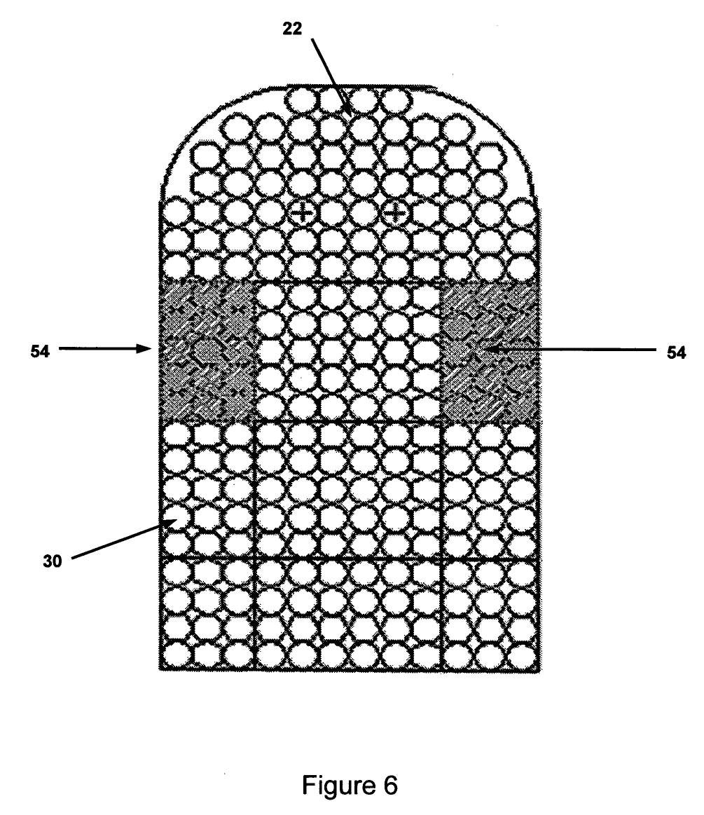

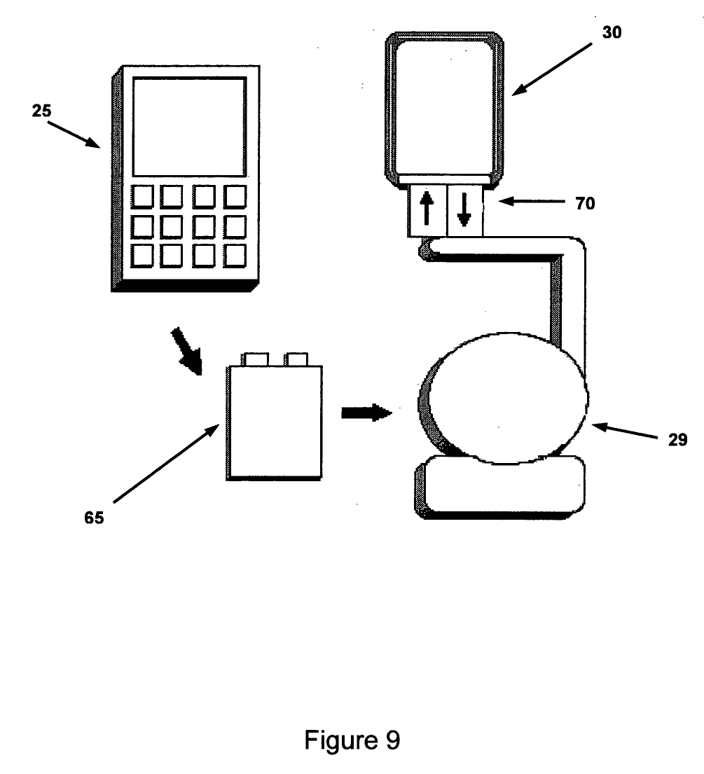

FIGS. 5 and 6 respectively illustrate the plurality of matrices of adjustable air cells 30 on respective seat bottom cushion 20 and seat back cushion surfaces 22. Although uniform in size as depicted in FIGS. 5 and 6, the cells may vary in size depending on their strategic placement within the seat for therapeutic support and comfort. As mentioned, each air cell may be individually inflated/deflated in the manner as will be explained in greater detail herein. As will be described in greater detail herein with respect to FIG. 9, a convenient control device or control panel 25 is provide with an intuitive control interface that enables the patient to control the inflation/deflation of the individual air cell or air cell matrices. The control device may comprise a remote controller, i.e., disconnected and operable via wireless communication for controlling the inflation/deflation of the individual air cell or air cell matrices. In one embodiment, the controller device may comprise a computer or like programmable logic controller device that may be programmed to control the timing of inflating/deflating each individual air cell or plurality of air cells and the amount of air cell inflation/deflation. Preferably, the air cells include individual bladders 52 (not shown) for strategic areas with the exception of side containment cells 54 located on the seat back cushion 22 (FIG. 6). For example, these two side containment cells 54 on the back seat cushion 22 depicted in FIG. 6 inflate at once for better lateral control of the patient.

As mentioned, the back support cushion 22 of FIGS. 1 and 6 includes a matrix of air cells 30 capable of being individually inflated and deflated or inflated in groups of cells with two side panels of air cells 54 on the seat back cushion 22 inflatable simultaneously. This back support cushion 22 is thus especially useful for patients with significant spinal deformity or severe weakness of the trunk muscles; or for patients who are expected to be in the wheelchair at least two hours per day. The seat back cushion 22 enhances the prolonged seating tolerance and provides postural support to permit functional activities, or pressure reduction.

Further, the seat bottom 20 and back support 22 cushions implement small compact cells with individual air bladders operable for strategic areas that can be fully controlled by the wheelchair patient, and, can be adjusted to any sized patient. All the air cells are individual with the exception of the side cells on the back support that are inflatable together for better lateral control of the patient. With the exception of the two side containment cells, any pattern of cells could be inflated. FIG. 6 shows the strategic placement of the air cells for support and comfort.

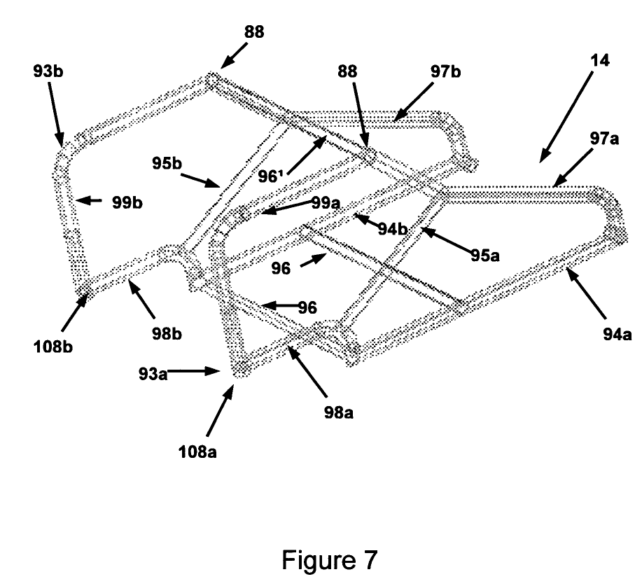

As mentioned, the wheelchair 10 includes a chassis 14 upon which the frame 2 including seat support 21 having seat bottom 57 and seat back 56 portions are supported. Referring to FIG. 7, there is depicted an isomeric view of the chassis 14 implemented in the wheelchair of the present invention. Preferably, the chassis 14 is customized to both support the wheelchair seat frame 2 and further prevent tilting or destabilization when positioned at any angle. The chassis 14 includes two side support portions 93a,b, each side support portion including a longitudinal base rail member 94a,b that are connected by cross members 96. Welded or otherwise affixed to each base rail member are respective arcuate-shaped members 98a,b that extend from the respective base rail members 94a,b toward the front of the chair. Fixed to each respective arcuate shaped member 98a,b at respective front ends 108a,b and extending upward and rearward therefrom are respective side shoulder rails 99a,b that provide mounting means at a lower end for securing the front caster wheels. Attached at the upper end of each side shoulder rails 99a,b is a mounting bracket 88 (shown in FIGS. 3 and 4) to which the wheel chair seat frame 2 is mounted. The mounting bracket 88 is further supported by an upper cross member 96′ that is fixedly supported at each end by angled side rail members 95a, 97a on one side and angled side rail members 95b, 97b on the other side. Angled side rail members 97a,b extend rearward and downward from upper cross member 96′ and each respective bracket as best shown in FIGS. 1 and 2. Suitable means are provided at each angled side rail member 97a,b for attaching wheel immobilizers (not shown) and, at a lower end of each angled side rail member 97a,b, mounting means are provided for attaching each of the rear wheels.

With respect to mounting of the seat frame to the chassis, as mentioned, the wheel chair frame 2 is mounted to the chassis 14 by welded brackets 88 (shown in FIGS. 3, 4 and 7) positioned on an upper cross member 96′ and top shoulder rail portions on each side of the chassis 14. The mounting brackets 88 accommodate a single bolt for mounting the frame 2 to the chassis 14. The bolt is provided with a plastic bushing through the frame 2 to allow for a smooth rotation when the wheelchair reclines.

Dimensionally, the minimum wheel base length needed to prevent tipping of the patient when the wheelchair is in an upright or reclined position (e.g., position A, FIG. 3) is dependant upon the total center of gravity of the person and seat. This distance may vary to counter the center of gravity, and is primarily dependent upon the size and weight of the person using the chair. For example, when in a substantially upright position, the rear wheels may be located at least 8 inches or more (along the horizontal) from the longitudinal position of the seat pivot point 33 when dropped down. In one embodiment, when designed for a 200 pound person sitting in a substantially upright position, the center of the rear wheel is positioned about 9.75 inches behind the pivot point 33. The displacement of the rear wheel provides additional stability allowing the patient to fully recline in a planar position without tipping.

When the patient reclines from an upright seating position to a planar position, the center of gravity of the patient shifts along a horizontal axis. The rear wheel is positioned to be just past the patient's center of gravity in the planar position, thereby providing maximum stability. In the chassis 14 shown in FIG. 7, the angled cross member 96 intersects perpendicularly with the right and left side support portions 93a,b of the chassis 14 to provide optimum strength and to support the frame 2 while in the planar recline position (A). When the wheelchair 10 is in position (A) the chassis 14 effectively lowers the center of gravity and the patient, thereby providing greater stability. This is in contrast to conventional wheelchairs where the patient is actually seated in the chassis, and, for example, the armrests are connected to the chassis. In the present invention, however, the chassis 14 supports the frame seat bottom portion 57 from underneath, i.e., the patient sits in the seat support 21 that is mounted over the frame, rather than sitting within the frame 2.

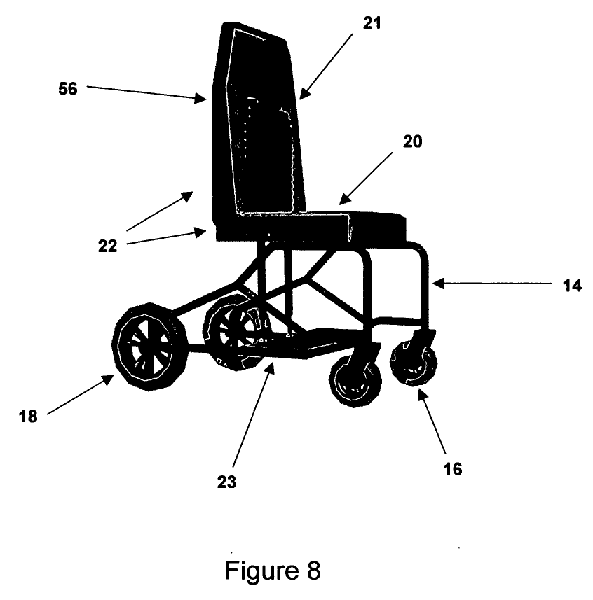

FIG. 8 illustrates a side view of the chassis 14 of wheelchair 10 and an internal view of the seat support 21 mounted thereon including the seat bottom cushion 20, seat back cushion 22, seat bottom 57, seat back 56, and the bottom plate 23. Preferably, the chassis 14 and frame 2 may be fully fabricated from any lightweight metal, and, in an exemplary embodiment, the chassis is fabricated from aluminum which is lightweight, strong, easy to machine and cost effective. Some steel and plastic components can be used in the chassis as well. The chassis size can be customized depending on the size of the patient. For example, the chassis may be designed to accommodate pediatric or obese patients. In one embodiment, the height of the wheelchair ranges from about 60 inches or less and the overall length is less than about 48 inches when not fully extended. The finished wheelchair complies with the restraints of all handicap accessibility environments (wheelchair ramps, doorways, bathrooms). As further shown in FIG. 8, the bottom plate 23 is fixedly mounted on a lower internal portion of the chassis 14, and provides sufficient room to hold the power source 28, any solenoids 70, air pump 29, and any control mechanisms. The wheels and casters are mounted directly to the chassis 14 via a bolt or other means. In one embodiment, shown in FIG. 8, the front caster wheels 16 are smaller than the rear drive wheels 18 and are spaced apart laterally and axially in such a way so that adequate support is provided to accommodate reclination of a patient at any desired angle, even planar. The front of the chair rides on swivel caster wheels 16 with rims. The casters may be solid rubber mold tire. In one embodiment, the diameter of the front wheels is between about 4-8 inches, preferably about 6 inches. The rear wheels are larger than the caster wheels and an additional tip prevention wheel (not shown) may be positioned behind the rear wheels.

FIG. 9 shows a schematic diagram of the air cell inflation/deflation system and, FIG. 10 shows a rear view of the air cell system suitably mounted on the chassis 14, e.g. under the seat bottom. As shown in FIG. 9, the remote control (interface) panel and control device 25 includes a power supply, e.g. a battery 65, and is connected to the air cell inflation/deflation means 29 (an air pump, compressor, hydraulic system, or like means for inflating/deflating) to supply airflow to one or more bank of solenoids 70 that control air flow to/from each air cell(s). Appropriate connection means is provided for transferring from each solenoid bank 70 the controlled amount of pressure to valves of the air pump. The valves are electronically actuated for releasing or providing pressure according to control signals from the controller device 25. The maximum output pressure of the means 29 to inflate and deflate the air cells, e.g. the pump, is critical. The means to inflate and deflate the air cells has to have the capacity to fill the cells with air while the patient is in the seat. The pump thus, is compact, lightweight, and runs off of the power source such as a 12-volt DC battery 65. Examples of suitable pumps 29 include pump designed to inflate a tire on a car and miniature 12-volt DC pumps, such as the Sensidyne™ pump that is used for medical purposes. The pump 29 is mounted on a bottom plate 23 (as shown in FIGS. 1 and 2) and connected to the seat bottom cushion 20 and back support cushion 22. The power to the system can be 12 volts DC provided by a lead acid battery. In an alternative embodiment, a rechargeable lithium ion battery or D cell batteries may be used.

As mentioned, the control panel or controller 25 is programmable so that a patient can change the pressure in specific air cells at set times, e.g. every 10 minutes. In one preferred embodiment, the control system 25 is a small Programmable Logic Controller (PLC) which is programmed to inflate and deflate the air cell matrices at set times, e.g. every one minute, every 5 minutes, every 20 minutes. The computer controls the cushion's operating sequences. The system will be time dependent and regulate the pressure in the air cells to change the distribution load of the patient on the chair thereby automatically performing a weight shift function. The programming of the controller for automatic inflation/deflation control can be performed in a manner suited for the individual patient. In another embodiment, the inflation/deflation control is operated manually via the controller. In one embodiment, the controller may be attached or mounted into the armrest of the wheelchair to control the system where the patient may be able to operate it. Alternatively, the controller may be remotely positioned on the patient's lap. The controller, can however, be placed anywhere that is most convenient to the patient. For example, in alternative embodiments, the controller could be on the edge of the seat or on the handlebar or may be remote and operable via a wireless communications.

As shown in the detailed view of FIG. 10, linked to the control panel is a bank of solenoids and valves 70 to control flow for each cell and a pump to supply the airflow. The solenoid valves inflate and deflate the air cells individually or in groups (matrices). Solenoids 70 are used to control flow into and out of each individual cell of a matrix. Depending on the type of solenoid used, a plurality of valves, e.g., two or more position valves or one four position valves may be required for air flow. If one two position valve is used, for example, the valve would simply open and close and therefore, on the exhaust side, would be merely releasing air into a dead pump. Example solenoids which may be used in the present invention include the series SY solenoid valves, such as the SY114 class solenoid (SMC Corporation). This solenoid is light, compact and inexpensive. Like solenoid mechanisms may also be used. As the sequencing, timing and pressure control may be patient controlled, the patient must enter or program into the controller the individual matrix of cells to be inflated and the amount of time before they are to be automatically deflated under program control. The time setting activates the pump and opens one of two solenoid valves. The two solenoid valves control airflow into the aircells. The inflated air cells gradually deflate through an exhaust port on the attached solenoid valve.

Preferably, the wheelchair of the present invention supports the weight of a child, normal adult and even obese patients ranging from a height from 50-76 inches. To determine the wheelchair stability, a total moment calculation, i.e., the weight of all wheelchair and accessory internal components, and the weight of a 200 pound person, for example, was calculated. After calculating the total moment created by all components, and the example occupant, positioning the rear wheel at a distance about 9.75 inches from the horizontal location of pivot point 33 of the wheelchair was determined to be optimal for a 200 pound person. This length insured that the wheelchair would not tip upon the chair being folded to the fully reclined position. Additionally, this length insured that an adequate safety factor exists given the occupant's weight. This safety factor allows the occupant to place more weight on the back support if need be in the case of having to lift the legs of the wheelchair when changing absorbent undergarments or diapers or physical therapy. It is within the purview of the skilled artisan to design lateral and axial placement of the wheels relative to the pivot point 33 to ensure stability and adequate safety factor.

It is particularly important that all concepts take into consideration center of gravity to prevent tipping. The method of de Leva, “Adjustments to Zatsiorsky-Selvyanov's segment inertia parameters”, J. Biomechanics 29(9): 1223-30, (1996), which is incorporated herein by reference was used to estimate body segment mass as a proportion of total body mass and the location of each segment's center of mass as a proportion of the segment length:

Segment Mass Percents

| Segment | Males | Females |
|---|---|---|
| Head & trunk | 6.944 | 6.68 |
| Trunk | 43.46 | 42.58 |
| Upper arm | 2.71 | 2.55 |
| Forearm | 1.62 | 1.38 |
| Hand | 0.61 | 0.56 |
| Thigh | 14.16 | 14.78 |
| Shank | 4.33 | 4.81 |

The reliability of the air cells and chassis is determined by using a safety factor which may range from about 1.6 to about 2.0 for the design and selection of all components of the wheelchair.

Although not shown, safety belts (i.e., restraints) may be provided for securing a patient's waist, chest and feet. A waist restraint may comprise a single nylon seatbelt connected by each hip and securing at the lower front of the abdomen. The chest harness may be a lightweight material connected to the chair at the top of each shoulder and both sides just above the waist. Each foot restraint is a single strap going over the foot from the inner arch to the outside. The strap remains secure via Velcro or similar connecting means. These safety belts are useful if the patient has weak upper body muscles, upper body instability or muscle spasticity which requires the use of these belts for proper positioning. For patients that require additional support, additional torso restraining straps may be attached to the seat back 14 and configured to wrap around the torso or abdomen of the patient to avoid slipping. In one embodiment, there is a pair of support straps each having a first end attached to the reclining chair back and a second end configured to wrap around a patient's torso.

The ergonomics designed in the wheelchair 10 addresses needs of both the patient and the caregiver or operator. The patient requires comfort and support while in the wheel chair and the operator requires the ease of steering and adjustability while operating the wheelchair: With respect to the patient, the air cell technology provided in the wheelchair controls pressure points as well as patient aspects such as spinal alignment. The operation of the wheelchair facilitates improvement of a patient's respiratory function, positioning, and joint stability, and minimizes the possibility of contractures. The adjustable air cells within the seating surfaces prevent decubiti. With respect to the operator who operates the seat/back reclining feature, several different arrangements as described herein may be used to accomplish the reclining of the back frame and cushion or to move the back frame relative to the seat frame. The seat back reclines independently. For example, alternatively, a cranking mechanism may be used to crank the seat flat. In another embodiment, a power mechanism can be used to recline the back of the seat. Since the chair is capable to recline to an even plane (flat), clothing or diaper changes, dental work, hairdressing and/or other daily patient hygienic or grooming activities and even physical therapy sessions could take place in the wheelchair. For instance, the lay flat feature allows the wheelchair patient to lie down without leaving the chair and relieves a caregiver from lifting a patient from the chair to perform daily routines such as changing clothes or providing physical therapy. For incontinent patients, the wheelchair functions as a changing chair. A caregiver is able to slide a diaper off a patient once the wheelchair is in a layflat position.

It is to be understood that the wheelchair of the present invention may be further equipped used with miscellaneous wheelchair accessories such as: heel loops, (intravenous) IV rods, oxygen carriers, step tube, amputee adapter, and anti-tipping device, power standing attachment, or arm trough, wheelchair baskets, bags or pouches, trays, cutout tables.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It will be appreciated by those skilled in the art that while the foregoing represents a description of the preferred embodiments of the invention, the true scope of the invention is to be considered having reference to the attached claims. It is also to be understood that the following claims are intended to cover all of the generic and specific features of the invention herein described and all statements of the scope of the invention which, as a matter of language, might be said to fall therebetween. Modifications and alterations are possible without departing from the broad scope of the claims.

What is claimed is:

1. A multifunctional wheelchair comprising:
a frame;
a seat mounted on the frame, the seat including a seat back and a seat bottom each of the seat back and seat bottom having a plurality of matrices of air cells which can be individually inflated and deflated;
a means to individually inflate and deflate one or more air cells in the plurality of matrices; and
a controller connected to said means to inflate and deflate to enable a patient to individually control inflation and deflation of one of more air cells in each of the plurality of matrices in the seat back and bottom.

2. The multifunctional wheelchair as in claim 1 further comprising the seat back capable of being reclined with respect to the seat bottom.

3. The multifunctional wheelchair as in claim 1 further comprising the seat being capable of being tilted with respect to said frame.

4. A multifunctional wheelchair comprising:
a frame;
a seat mounted on the frame, the seat including a seat back and a seat bottom each of the seat back and seat bottom having a plurality of matrices of air cells which can be individually inflated and deflated, the seat back capable of being reclined with a range of from about 90° to about 180° with respect to the seat bottom;
a means to individually inflate and deflate one or more air cells in the plurality of matrices; and
a controller connected to said means to inflate and deflate to enable a patient to individually control inflation and deflation of one or more air cells in each of the plurality of matrices in the seat back and bottom.

5. The multifunctional wheelchair as in claim 1 or 4, further comprising a controller that is programmable so that the plurality of matrices of individual air cells can be individually inflated and deflated in a predetermined time interval.

6. A multifunctional wheelchair comprising:
a frame;
a seat mounted on the frame, the seat including a seat back and a seat bottom each of the seat back and seat bottom having a plurality of matrices of air cells which can be individually inflated and deflated, the seat back capable of being reclined with respect to the seat bottom and said seat capable of being tilted with respect to said frame;
a means to individually inflate and deflate one or more air cells in the plurality of matrices; and
a controller connected to said means to inflate and deflate to enable a patient to individually control inflation and deflation of one or more air cells in each of the plurality of matrices in the seat back and bottom.

7. A multifunctional wheelchair comprising:
a frame;
a seat mounted on the frame, the seat including a seat back and a seat bottom; the seat back capable of being reclined with respect to the seat bottom and said seat capable of being tilted with respect to said frame.

8. The multifunctional wheelchair of claim 6, further comprising a power source mounted to the frame, said power source being capable of supplying power to a means to inflate and deflate the air cells.

9. The multifunctional wheelchair of claim 6, further comprising a leg support assembly, the leg support assembly being capable of rotation to a flat position, such that said wheelchair assumes a horizontal position when the seat back is reclined.

10. The multifunctional wheelchair of claim 6, further comprising gas springs for tilting the seat.

11. The multifunctional wheelchair of claim 6, said plurality of matrices of air cells located in said seat back and said seat bottom being grouped in zones capable of individual inflation.

12. The multifunctional wheelchair of claim 6, wherein said means for inflating/deflating include:
a) an air pump;
b) one or more solenoid banks including valves;
c) a means for receiving control signals from said control device;
wherein said controller is further attached to a bank of solenoids which control the pump to inflate and deflate the air cells.

13. The multifunctional wheelchair of claim 6, wherein said seat back is capable of reclining with a range of from about 90° to about 180°.

14. The multifunctional wheelchair of claim 6, further comprising an arm support.

15. The multifunctional wheelchair of claim 14, wherein the arm support is capable of being tilted with the seat back so that the angle of the arm support with the seat bottom is not changed.

16. The multifunctional wheelchair of claim 6, further comprising a pair of support straps each having a first end attached to the reclining chair back and a second end configured to wrap around a patient's torso.

17. A method for using a multifunctional wheelchair comprising:
seating a patient upon a seat support of a wheelchair which reclines and tilts;
programming a controller to activate a means to inflate or deflate individual air cells of the seat support; and
releasing air from the inflated seat support if overinflation occurs.

18. A method of ameliorating decubiti ulcers comprising:
providing a wheelchair that reclines and tilts with a seating and back apparatus therein, said seating and back apparatus comprising:
a plurality of matrices of air cells, said cells being capable of being individually inflated and deflated;
a controller allowing the patient to individually program inflation and deflation of the air cells;
sitting an immobilized person on said wheelchair, said person having a decubitus ulcer on a lower body region thereof; and
inflating and deflating air cells on an individual basis, whereby pressure is relieved in said lower body region.

19. A method of preventing decubiti ulcers comprising providing a multifunctional wheelchair whereby a patient can individually inflate and deflate air cells in a seat support and a reclining back and tilting frame thereby relieving pressure and friction forces on back and lower body regions.

20. A method of transforming a multifunctional wheelchair into a side lyer comprising: inflating air cells on one side of a seat bottom and seat back; and placing a person in a side lying position thereon.

21. The multifunctional wheelchair of claim 6, further comprising rear wheels, wherein displacement of the rear wheels prevents tipping of the wheelchair when a patient in the seat is in a planar position.
